(19) United States
(12) Patent Application Publication
(10) Pub. No.: US 2011/0314361 A1
(43) Pub. Date: Dec. 22, 2011

(54) GENERATING RECOMMENDATIONS FOR IMPROVING A PRESENTATION DOCUMENT

(75) Inventors: Jeffrey Chao-Nan Chen, Cupertino, CA (US); Barn-Wan Li, San Jose, CA (US); Daniel Cheung, Mountain View, CA (US); Jason Xiaobo Zhao, San Jose, CA (US); Xiaosa Zhao, San Jose, CA (US)

(73) Assignee: Microsoft Corporation, Redmond, WA (US)

(21) Appl. No.: 12/819,232

(22) Filed: Jun. 21, 2010

(51) Int. Cl. G06F 17/00; G06F 3/01

(52) U.S. Cl. 715/204; 715/730

(57) ABSTRACT

User actions, content, and other elements related to a presentation document are received. These elements are analyzed to generate recommendations for improving a presentation document. The presentation document may be modified in accordance with the recommendations.

### BACKGROUND

The use of electronic presentations has become increasingly common in many areas of business and academia. By combining text with media such as images, video, and audio, users may be able to depict and share ideas and information in a dynamic and engaging way. However, in order to create an effective electronic presentation, it is often necessary for the user that creates the electronic presentation to possess a certain level of artistic ability, design sense, and aesthetic sensibility. Consequently, it is not uncommon for users without keen aesthetic sensibilities to create presentation documents wherein one element (such as a graphic or video) is not aesthetically consistent with another element (such as an audio soundtrack or the color of an item of text or a background) or the presentation document as a whole. This challenge is further compounded by the fact that while individual frames, or slides, of a presentation document are often prepared independently of one another, the document as a whole is generally displayed as one continuous presentation. As a result, many users may create elements or frames that are inconsistent with the aesthetic appearance a presentation as a whole.

It is with respect to these and other considerations that the disclosure made herein is presented.

### SUMMARY

Concepts and technologies are described herein for, among other things, generating recommendations for improving a presentation document by analyzing user actions and content related to a presentation document. Through an implementation of the technologies and concepts presented herein, user actions, content, and other elements related to a presentation document can be analyzed to generate recommendations for improving the presentation document, thereby enabling users that might not possess significant artistic or creative abilities to create more dynamic, engaging, and aesthetically consistent presentations.

According to one aspect disclosed herein, user actions and editing actions (which may be referred to herein as “actions”) are identified from within a presentation application. These actions represent various inputs and events performed and/or occurring during the creation and editing of a presentation document. An analysis engine analyzes these actions to generate recommendations for improving the presentation document. The presentation document may then be modified in accordance with the identified recommendations.

According to other aspects, content associated with a presentation document is identified. The content might take the form of text, graphics, audio, video, or any other such data element incorporated into a presentation document. The analysis engine analyzes the content to identify recommendations for improving the presentation document. The presentation document may then be modified in accordance with the identified recommendations. According to various embodiments, the recommendations may be applied with or without requiring user input.

According to other aspects, context data associated with a presentation document is received. The context data might take the form of meta-data (such as the time of day or year that a presentation document is created) that serves to provide additional context for and insight into a presentation document. The analysis engine analyzes the context data to identify recommendations for improving the presentation document. The presentation document may then be modified in accordance with the identified recommendations.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer hardware and software architecture diagram showing aspects of a computer, a presentation document, a presentation application, and an analysis engine provided in various embodiments disclosed herein;

FIG. 2 is a software architecture diagram showing additional aspects of an analysis engine provided herein;

FIGS. 3 and 4 are flow diagrams illustrating aspects of the operation of the analysis engine according to one embodiment disclosed herein; and

FIG. 5 is a computer architecture diagram showing an illustrative computer hardware and software architecture for a computing system capable of implementing the embodiments presented herein.

### DETAILED DESCRIPTION

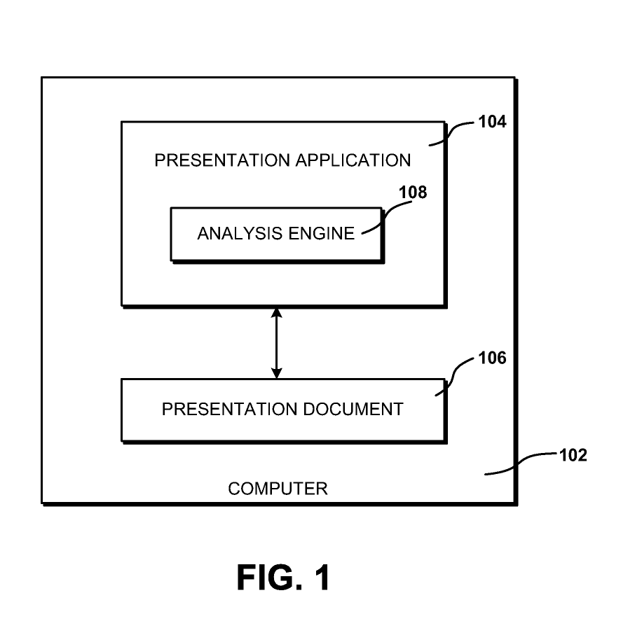

The following detailed description is directed to concepts and technologies for generating recommendations for improving a presentation document. User actions, editing actions, content, and context data may be identified from within a presentation application and/or a presentation document. These and other elements related to a presentation document may be received by an analysis engine and analyzed in order to generate recommendations for improving the presentation document. The presentation document may then be modified in accordance with the generated recommendations. Additional aspects regarding these operations will be provided below with reference to FIGS. 1-5.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for generating recommendations for improving a presentation document will be presented.

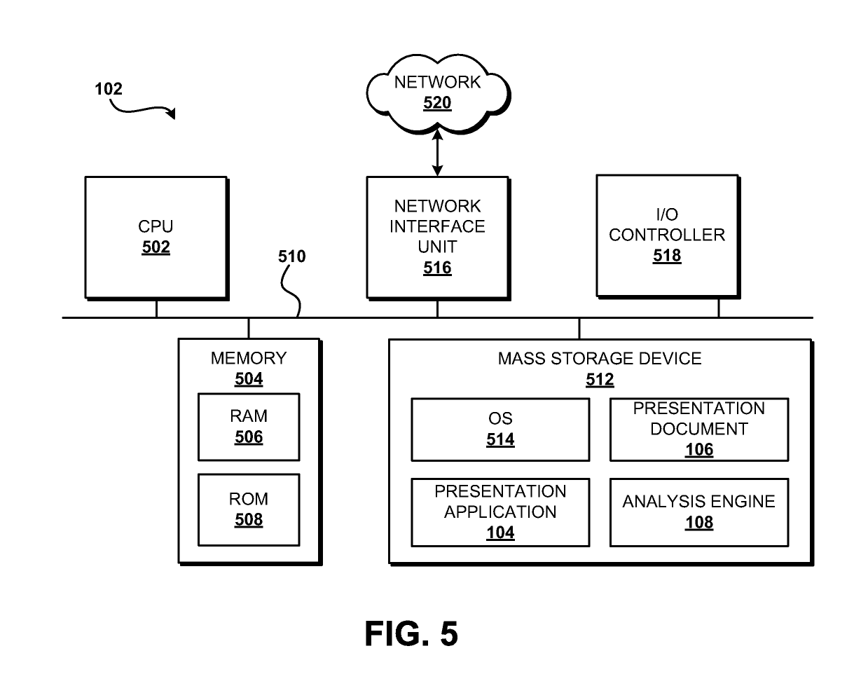

Referring now to FIG. 1, a computer hardware and software architecture diagram will be described that shows aspects of the operation of a computer 102 and several software components provided herein. As depicted in FIG. 1, a presentation application 104 executes on the computer 102. While computer 102 will be discussed in greater detail below with respect to FIG. 5, it should be noted that computer 102 might be any conventional desktop or laptop computer, handheld device, or server computer capable of executing a presentation application.

The presentation application 104 is a software program that enables a user to create and/or modify a presentation document 106. One example of a presentation application 104 is the POWERPOINT presentation application from MICROSOFT CORPORATION of Redmond, Wash. It should be appreciated, however, that any software program or module that enables a user to create and/or modify a presentation document might be considered a presentation application. The presentation document 106 is a computer-readable file that is readable by the presentation application 104 and that includes data storing an electronic presentation. As will be described in greater detail below, various forms of content such as text, graphics, video, and audio may be included within a presentation document 106.

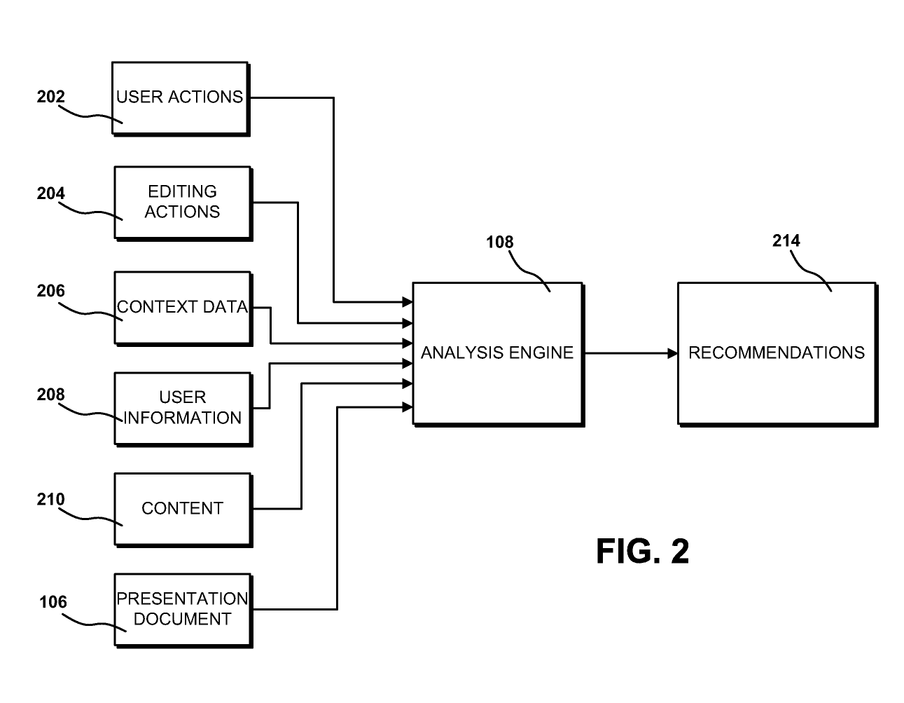

The analysis engine 108 is an executable software component that executes within or in conjunction with the presentation application 104. As will be described in greater detail below, the analysis engine 108 identifies various actions, content, and other elements related to a presentation document. The analysis engine 108 analyzes these items to generate recommendations for improving the presentation document 106. It should be noted that while in one embodiment the analysis engine 108 executes within presentation application 104, in other embodiments the analysis engine 108 may operate as a stand-alone component. For instance, the analysis engine 108 may execute on a network-accessible server computer that can be accessed by the presentation application 104 through an appropriate network. Additional details regarding the operation of the analysis engine 108 will be provided below with regard to FIGS. 2-4.

Turning now to FIG. 2, a software architecture diagram will be described that shows additional aspects regarding the operation of the analysis engine 108 according to the various embodiments presented herein. As shown in FIG. 2, the analysis engine 108 receives user actions 202 and editing actions 204. User actions are inputs and/or selections made by a user during the preparation of the presentation document 106. Examples of user actions 202 include, but are not limited to, the input of text or media into the presentation document 106. Editing actions are inputs and/or selections made by user when modifying a previously created presentation document 106. Examples of editing actions 204 include, but are not limited to, modifying element properties and adding content.

According to embodiments, the analysis engine 108 also identifies and receives context data 206. Context data is meta-data that further define aspects of the presentation document 106. Examples of context data 206 include, but are not limited to, the time of day and year that the presentation document 106 was created and the geographic location where the presentation document 106 was created. It should be noted that while in one embodiment the context data 206 originates at a local user device such as computer 102, in other embodiments the context data 206 might originate at an external source. For example, the analysis engine 108 might identify context data by consulting an external server or World Wide Web (“Web”) Web site to determine the date, time, and/or location that a presentation document 106 was created.

According to embodiments, the analysis engine 108 also identifies and receives user information 208. User information 208 is information related to the user who creates and/or edits the presentation document 106. Examples of user information include, but are not limited to, Web browsing history, document creation and access history, audio/video file playlists, and user profiles. It should be understood that while in one embodiment the user information 208 may originate at a local user device such as computer 102, in other embodiments the user information 208 may originate at an external source. By way of example, the analysis engine 108 might identify user information 208 by accessing a user profile stored on a social networking Web site.

The analysis engine 108 also identifies and receives content 210. Content 210 includes data elements that are assembled in order to create a presentation document 106. Examples of content include, but are not limited to, text, images, audio, video, or any other data elements that might be incorporated into a presentation document 106. In a similar vein, the analysis engine 108 identifies and receives the presentation document 106. Though the analysis engine 108 has identified and received the content 210 that is assembled within the presentation document 106, the analysis engine 108 also identifies and receives the presentation document 106 itself, which includes data identifying the various frames within the presentation, the layout of the content 210 on the frames, and other data.

Upon identifying and receiving the user actions 202, the editing actions 204, the context data 206, the user information 208, the content 210, and the presentation document 106, the analysis engine 108 analyzes these elements, as will be described in greater detail below. In doing so, the analysis engine 108 identifies one or more recommendations 214 that may serve to improve the presentation document 106. The recommendations 214 may then be presented to a user and, if the user approves, the presentation document 106 may then be modified in accordance with the recommendations 214, as will also be described in greater detail below.

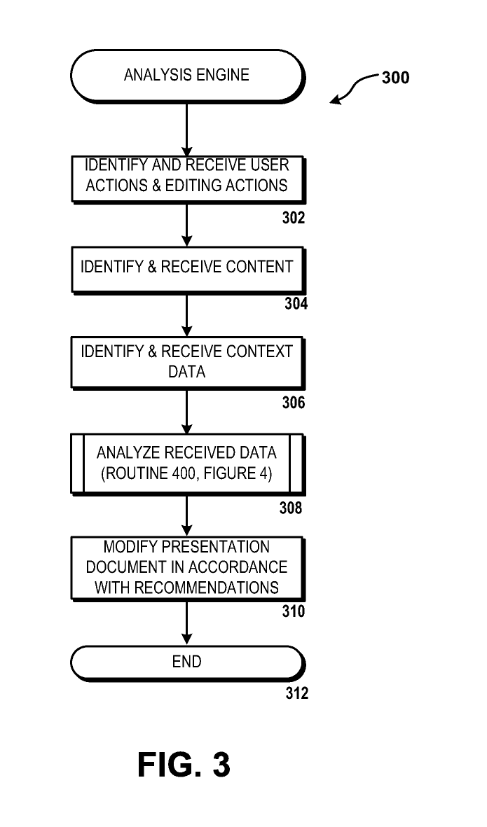

Turning now to FIG. 3, a flow diagram will be described showing a routine 300 that illustrates various operations performed by the analysis engine 108 in one embodiment disclosed herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at block 302 where the analysis engine 108 identifies and receives user actions 202 and editing actions 204 that relate to a presentation document 106, as discussed above. From operation 302, the routine 300 proceeds to operation 304, where the analysis engine 108 identifies and receives content 210 from the presentation document 106. From operation 304, the routine 300 proceeds to operation 306, where the analysis engine 108 identifies and receives context data 206 relating to the presentation document 106.

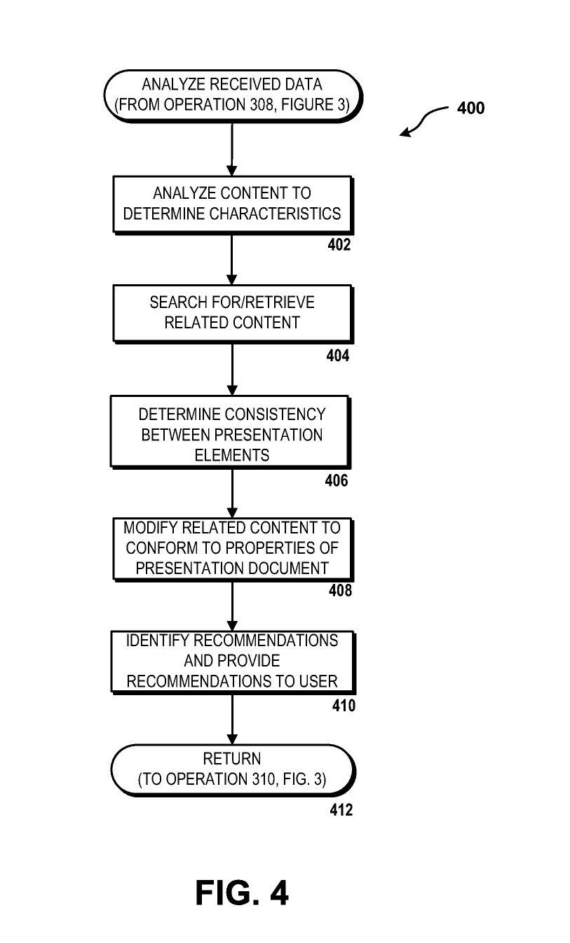

From operation 306, the routine 300 proceeds to operation 308, where the analysis engine 108 analyzes the received data. This process is described below with regard to FIG. 4. From operation 308, the routine 300 proceeds to operation 310, where the presentation document 106 is modified in accordance with the provided recommendations 214. In one embodiment, the user may be presented with one or more recommendations, and the user may select which recommendation or recommendations they wish to apply to the presentation document 106. In an alternative embodiment, one or more recommendations may be applied without requiring user input. Upon modifying the presentation document 106 in accordance with one or more recommendations 214 at operation 310, the routine proceeds to operation 312 where it ends.

Turning now to FIG. 4, a routine 400 will be described that depicts a process performed by the analysis engine 108 for analyzing received data and for identifying recommendations according to one embodiment disclosed herein. The routine 400 begins at operation 402 where the analysis engine 108 analyzes the received content 210 to determine characteristics of the content 210. By way of example, a histogram may be generated for a graphical element, the beat or tone of an audio element may be detected, and the length of a video file may be measured.

From operation 402, the routine 400 proceeds to operation 404, where the analysis engine 108 searches for and retrieves content related to the received user actions 202, editing actions 204, context data 206, user information 208, content 210, and presentation document 106. For example, the analysis engine 108 may utilize an search engine to find and retrieve media that relates to text found within a presentation document or that relates to a Web site that the user frequently visits.

From operation 404, the routine 400 proceeds to operation 406, where the analysis engine 108 determines the consistency amongst the various received presentation elements including the user actions 202, editing actions 204, context data 206, user information 208, content 210, presentation document 106, as well as the related content retrieved at operation 404, as described above. In doing so, the analysis engine 108 may compare one element or aspect of or relating to the presentation document 106 with another one or more element(s) or aspect(s) of the presentation document.

By way of example, the analysis engine 108 may compare a histogram for a graphical element contained within a presentation document 106 (generated above at operation 402) with the text color and size used within the presentation document 106. By way of further example, the analysis engine 108 may compare various graphical elements (such as images and colors) contained within a presentation document 106 with the beat or tone of an audio element included in the presentation document 106. In doing so, the analysis engine 108 is able to determine which elements within the presentation document 106 are consistent with one another, and which are inconsistent. For instance, if the analysis engine 108 determines that an audio clip has been inserted into the presentation document 106 that has an aggressive style, the analysis engine 108 might determine that the audio clip is inconsistent with other presentation elements that have a subtle style (e.g. text or images having subtle hues). From operation 406, the routine 400 proceeds to operation 408.

At operation 408, the analysis engine 108 might modify the content retrieved at operation 404 to conform to the characteristics of the presentation document 106. By way of example, the analysis engine 108 may utilize a background removal tool to remove the background of an image file retrieved from the Internet so that the image file better conforms to the color scheme or other such graphical elements present in the presentation document 106. Other types of modifications might be made to inserted content in order to conform the inserted content into the style of the presentation document 106.

From operation 408, the routine 400 proceeds to operation 410, where the analysis engine 108 identifies recommendations 214 for improving the presentation document 106 and provides the recommendations to a user. As discussed briefly above, the recommendations 214 may take the form of modifications to practically any element and/or aspect of the content 210 of the presentation document 106. By way of example, the recommendations 214 may include modifications to text included in the presentation document 106 (such as changing font size or coloring), the selection of an alternative background/color scheme, and the use of alternative audio or video elements. From operation 410, the routine proceeds to operation 310 where the presentation document 106 may be modified in accordance with the provided recommendations 214 if the user approves, as described in detail above.

FIG. 5 shows an illustrative computer architecture for a computer 102 capable of executing the software components described herein for generating recommendations for improving a presentation document. The computer architecture shown in FIG. 5 illustrates a conventional desktop, laptop computer, or server computer and may be utilized to execute the various software components described herein.

The computer architecture shown in FIG. 5 includes a central processing unit 502 (“CPU”), a system memory 504, including a random access memory 506 (“RAM”) and a read-only memory (“ROM”) 508, and a system bus 510 that couples the memory to the CPU 502. A basic input/output system (“BIOS”) containing the basic routines that help to transfer information between elements within the computer 102, such as during startup, is stored in the ROM 508. The computer 102 further includes a mass storage device 512 for storing an operating system 514, application programs, and other program modules, which will be described in greater detail below.

The mass storage device 512 is connected to the CPU 502 through a mass storage controller (not shown) connected to the bus 510. The mass storage device 512 and its associated computer-readable media provide non-volatile storage for the computer 102. Although the description of computer-readable media contained herein refers to a mass storage device, such as a hard disk or CD-ROM drive, it should be appreciated by those skilled in the art that computer-readable storage media can be any available computer storage media that can be accessed by the computer 500.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 102. As used herein, the term computer-readable storage media does not encompass transitory signals.

According to various embodiments, the computer 102 may operate in a networked environment using logical connections to remote computers through a network such as the network 520. The computer 102 may connect to the network 520 through a network interface unit 516 connected to the bus 510. It should be appreciated that the network interface unit 516 may also be utilized to connect to other types of networks and remote computer systems. The computer 102 may also include an input/output controller 518 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 512 and RAM 506 of the computer 102, including an operating system 514 suitable for controlling the operation of a networked desktop, laptop, or server computer. The mass storage device 512 and RAM 506 may also store one or more program modules and related data. In particular, the mass storage device 512 and the RAM 506 may store the presentation application 104, the presentation document 106, the analysis engine 108, and any or all of the other program modules described above. The mass storage device 512 and RAM 506 may also store other program modules and data.

In general, software applications or modules may, when loaded into the CPU 502 and executed, transform the CPU 502 and the overall computer 102 from a general-purpose computing system into a special-purpose computing system customized to perform the functionality presented herein. The CPU 502 may be constructed from any number of transistors or other discrete circuit elements, which may individually or collectively assume any number of states. More specifically, the CPU 502 may operate as one or more finite-state machines, in response to executable instructions contained within the software or modules. These computer-executable instructions may transform the CPU 502 by specifying how the CPU 502 transitions between states, thereby physically transforming the transistors or other discrete hardware elements constituting the CPU 502.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for generating recommendations for improving a presentation document have been presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and storage mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing recommendations to improve a presentation document, the computer-implemented method comprising performing computer-implemented operations for:
identifying one or more user actions performed in the preparation of the presentation document;
identifying content associated with the presentation document;
analyzing the user actions and the content to identify one or more recommendations for improving the presentation document; and
modifying the presentation document with the identified recommendations.

2. The computer-implemented method of claim 1, wherein analyzing the user actions and the content comprises analyzing the content to identify one or more characteristics of the content.

3. The computer-implemented method of claim 1, wherein analyzing the user actions and the content further comprises determining whether a first aspect of the presentation document is consistent with a second aspect of the presentation document.

4. The computer-implemented method of claim 3, wherein the recommendations comprise modifications to the presentation document to make the first aspect of the presentation document consistent with the second aspect of the presentation document.

5. The computer-implemented method of claim 1, wherein modifying the presentation document comprises presenting the recommendations to a user.

6. The computer-implemented method of claim 5, wherein modifying the presentation document further comprises receiving a selecting of a recommendation from the user and modifying the presentation document in accordance with the selected recommendation.

7. The computer-implemented method of claim 1, wherein the recommendations comprise recommendations for improving content contained in the presentation document.

8. The computer-implemented method of claim 1, wherein modifying the presentation document further comprises modifying the presentation document without requiring user input.

9. A computer-implemented method for providing recommendations to improve a presentation document, the computer-implemented method comprising performing computer-implemented operations for:
receiving user actions from a presentation application, the user actions comprising operations performed in the preparation of the presentation document;
receiving content for inclusion in the presentation document;
receiving context data defining aspects of the context in which the presentation document is being created;
analyzing the user actions, the content, and the context data with an analysis engine to identify one or more recommendations for improving the presentation document; and
modifying the presentation document with the identified recommendations.

10. The method of claim 9, wherein said context data is obtained from a user device.

11. The method of claim 9, wherein said context data is obtained from an external source.

12. The method of claim 9, further comprising receiving user information and wherein the user information is analyzed to identify the recommendations.

13. The method of claim 9, wherein analyzing the user actions, the content, and the context data further comprises determining whether a first aspect of the presentation document is consistent with a second aspect of the presentation document.

14. The method of claim 9, wherein analyzing the user actions, the content, and the context data further comprises searching for and retrieving content and data related to the user actions, the content, and the context data.

15. The method of claim 14, wherein analyzing the user actions, the content, and the context data further comprises modifying the related content and data to conform to one or more properties of the presentation document.

16. The method of claim 9, wherein the recommendations comprise recommendations for improving content contained in the presentation document.

17. The method of claim 9, wherein modifying the presentation document comprises modifying a first aspect of the presentation document to conform to a second aspect of the presentation document.

18. The method of claim 9, wherein modifying the presentation document comprises providing recommendations to a user.

19. The method of claim 9, wherein modifying the presentation document further comprises receiving a selecting of a recommendation from a user and modifying the presentation document in accordance with the selected recommendation.

20. A computer-readable storage medium having computer-executable instructions stored thereupon which, when executed by a computer, cause the computer to:
identify one or more user actions performed during preparation of the presentation document;
identify one or more editing actions performed during editing of the presentation document;
identify content associated with the presentation document;
identify context data defining aspects of the context in which the presentation document is being created;
identify user information;
analyze the user actions, the editing actions, the content, the context data, and the user information to identify one or more recommendations for improving the presentation document; and to
modify the presentation document with the identified recommendations.
